(19) United States
(12) Patent Application Publication
(10) Pub. No.: US 2024/0135948 A1
(43) Pub. Date: Apr. 25, 2024

(54) ACOUSTIC ECHO CANCELLATION

(71) Applicant: Audiotelligence Limited, Cambridge, Cambridgeshire (GB)

(72) Inventors: David Anthony BETTS, Cambridge, Cambridgeshire (GB); Mohammad A DMOUR, Cambridge, Cambridgeshire (GB)

(21) Appl. No.: 18/546,176

(22) PCT Filed: Feb. 8, 2022
(86) PCT No.: PCT/EP2022/053041

§ 371 Date: Aug. 11, 2023

(30) Foreign Application Priority Data
Feb. 12, 2021 (GB) 2101965.8

(51) Int. Cl. G10L 21/0208

(52) U.S. Cl. CPC G10L 21/0208

(57) ABSTRACT

A method of capturing speech using a television system comprising a microphone device and a playback device. A playback device of the television system plays a tv audio signal to generate acoustic tv audio and a microphone of the television system captures a speech audio signal comprising a mixture of speech from a user and the acoustic tv audio. The method obtains a representation of the tv audio signal that lacks a well-defined synchronization with the tv audio signal and processes the speech audio signal using a semi-blind source separation process to separate the speech from the user from the acoustic tv audio.

### TECHNICAL FIELD OF THE INVENTION

This invention relates to methods, apparatus and computer program code for use in separating e.g., speech from an acoustic audio. An example application uses blind source separation to isolate a speech audio from the acoustic audio of a television system, for example where a playback device and microphone are co-located. For example, speech may be separated from an acoustic audio by semi-blind source separation, in particular, guided by a reference audio.

### BACKGROUND TO THE INVENTION

Acoustic echo cancellation is a historic problem associated with the field of telecommunications, where solutions have been developed as early as the 1960s. Originally, in the particular case of a telephone system, acoustic echo manifested at the other end of a telephone line as an echo of a caller's own voice. Generally speaking, however, the problem of acoustic echo can occur in any environment in which there is a microphone in the vicinity of a loudspeaker, with the result that the microphone will pick up whatever sound the loudspeaker is emitting, as well as any other nearby acoustic sources.

Therefore, in general, acoustic echo cancellation (AEC) relates to the prediction and removal of the contents of one signal from another. In the case of a telephone system, acoustic echo cancellation attempts to predict a component of the telephone receiver signal that will be received at the telephone microphone and subtract that component, thus reducing or eliminating the echo (e.g., the caller's own voice). Generally, the receiver signal from which the prediction is derived may be called a reference.

It will be understood that the ‘echo’ is not necessarily an echo in the acoustic sense, and can for example be the undesirable recording of a speaker's own voice at a remote telephone system's microphone/receiver.

The known historic solutions to AEC have used adaptive filters (both analogue and digital filters have been known for several decades) that simulate the reflections and time delays taken by an acoustic path as it travels around a room from a speaker to microphone. For example, a Widrow-Hoff LMS (least mean square) adaptive filter is a historic solution, that has been implemented in analogue.

Presently, AEC may find utility in more fields than simply telecommunications; for example, mobile devices such as smart phones may have a speaker and microphone that are co-located. Thus, AEC may be used to remove a remote caller's voice from being transmitted back. More generally, AEC can be used to capture and understand a user's voice, for example when giving a voice command to a smart device, in the presence of any sounds being played from the smart device's own speaker.

However, known AEC techniques still require that a reference signal (i.e., the audio signal that will be played from a loudspeaker/playback device) and the mic inputs share a common word clock. The word clock is used to synchronise the digital samples so that there is no drift between the audio samples received at the mic and the reference audio samples. In the absence of a common clock, a timing drift can occur that may render AEC ineffective, or unusable. For example, over the course of an hour at a 16 kHz sample rate, the two sample streams (mic and reference) may drift by up to 5760 samples relative to each other. However, even a drift of a few samples can destroy the efficacy of the prediction in removing the echo.

In some devices and audio/communication systems, it is either not practical or not possible to share a common word clock. The present disclosure therefore seeks to address problems such as these and to describe advantageous solutions to AEC, in particular in relation to capturing speech of a user, e.g. when it is not possible to provide a synchronised reference signal.

Abad et al, “Deliverable D3.2 Multi-microphone front-end” (2013) discloses a number of techniques for source localization, acoustic echo cancellation, source enhancement, event detection and classification, and related experimentation. Nesta et al, “Batch-Online Semi-Blind Source Separation Applied to Multi-Channel Acoustic Echo Cancellation” (2011) discusses issues relating to the implementation of a semi-blind source separation system, including a matrix constraint to reduce the effect of the non-uniqueness problem caused by highly correlated far-end reference signals during multichannel acoustic echo cancellation.

### SUMMARY

According to one aspect there is therefore provided a method of capturing speech using a television system, the television system comprising a microphone device and a playback device. The method comprises: using a first, playback device of the television system to play a tv audio signal to generate acoustic tv audio representing the tv audio signal; using a microphone in a second, microphone device of the television system to capture a speech audio signal comprising a mixture of a first acoustic audio source comprising speech from a user and a second acoustic audio source comprising the acoustic tv audio; obtaining a representation of the tv audio signal, e.g. wherein the representation of the tv audio signal lacks (need not have) a well-defined synchronization with the tv audio signal; and processing the speech audio signal using a semi-blind source separation process to separate the speech from the user from the acoustic tv audio and determine at least one audio signal component comprising the speech from the user and in which the acoustic tv audio is suppressed, wherein the semi-blind source separation process uses the representation of the tv audio signal to guide the separation of the speech from the user from the acoustic tv audio, and wherein the at least one audio signal component comprises the captured speech.

The semi-blind source separation advantageously does not rely on a common word clock between the playback device (e.g. any device capable of providing an acoustic audio output) and the microphone device. Further advantageously, the speech audio signal and the representation need not be precisely aligned in order for the speech to be removed from the acoustic tv audio. The representation obviates the need for a common word clock, because the representation is used to help the blind source separation process to distinguish a user's speech from the acoustic tv audio. As such, the separation is ‘semi-blind’ in the sense that the separation process is able to separate the speech audio signal into separate acoustic sources, and determine a source of interest (e.g., a user's speech) using the representation. It will be appreciated, however, that the underlying separation process may readily be applied to separate any desired acoustic source from the second acoustic audio source, and would not be limited to separating a user's speech.

In examples, it will be understood that the acoustic tv audio may be referred to generally as an echo return, where echo return generally relates to any acoustic source not corresponding to a target source (e.g., a target source may be a user's speech).

Further, the relative positions of the playback device and the microphone device need not be known in advance. In preferable examples, the microphone device may comprise multiple microphones, which may enable more reliable separation of the speech from the user from the acoustic tv audio, in particular where the captured speech audio signal comprises audio from more than two sources (for example, containing background noise and/or acoustic reflections from a room).

Yet further, the semi-blind source separation process may be implemented anywhere, and is not restricted to being comprised in software or hardware of the microphone device or playback device. For example, the semi-blind source separation may be comprised/implemented in a further device (which could be local, or remote), where the further device is in communication with the microphone device (e.g., operable to receive the speech audio signal captured by the microphone device) and has access to the representation of the tv audio signal. The semi-blind source separation process may thus be implemented in the cloud, or a remote server.

In some embodiments, the semi-blind source separation process may comprise a process that separates the speech from the user from the acoustic tv audio dependent upon an information content of the speech and the acoustic tv audio.

The separation is therefore dependent on an information content as opposed to, e.g. geometric considerations such a beamforming technique. Advantageously, by separating the speech component using only an information content of the speech and acoustic TV, the system requires no knowledge or indication of the location of any of the speech from the user, the acoustic tv audio, or an environmental echo or reverberation resulting from either of these acoustic sources. In other words, the result of the semi-blind source separation can be achieved given any relative location of the user and microphone device, and without prior knowledge of said relative location.

In some implementations, processing the speech audio signal using the semi-blind source separation process may determine a plurality of the audio signal components, further including an audio signal component comprising the acoustic tv audio and in which the speech from the user is suppressed; and wherein using the representation of the tv audio signal to guide the separation of the speech from the user from the acoustic tv audio comprises resolving a source ambiguity by identifying one or more of the audio signal components which are similar to the acoustic tv audio.

Each component may correspond to a different acoustic source. Therefore, the semi-blind source separation may determine which of the acoustic sources corresponds to a source comprising predominantly the acoustic tv audio (e.g., an echo return, in which a user's voice is suppressed or absent). Advantageously, by determining which of the one or more components (e.g. acoustic sources) corresponds to the acoustic tv audio/echo return, a remaining source/component can be identified that comprises predominantly a user's speech (i.e. in which the tv acoustic audio is suppressed or absent) by process of elimination.

In some implementations, the microphone may comprise a microphone array, the method comprising using the microphone array to capture a multichannel speech audio signal, each channel of the multichannel speech audio signal comprising a mixture of speech from a user and the acoustic tv audio, and processing the channels of the speech audio signal using the semi-blind source separation process to separate the speech from the user from the acoustic tv audio.

Providing a microphone array with a plurality of microphones can improve the ability of the blind source separation to determine one or more audio signal components corresponding to separate acoustic sources. Thus, providing more microphones may provide a more reliable semi-blind source separation process. In other contexts and examples, it will be appreciated that a ‘channel’ may instead relate to separated output source corresponding to a particular acoustic source, rather than a microphone channel in a multi-mic device.

In some implementations, the semi-blind source separation process may comprise converting the speech audio signal to time-frequency domain data comprising a succession of time-frequency data frames for a succession of time windows, each having a plurality of frequency bands, and determining a set of de-mixing matrices, one for each of the frequency bands, to apply to each time-frequency data frame to separate the speech from the user and the acoustic tv audio, the set of de-mixing matrices defining a vector of separated outputs.

In some implementations, each row of one of the de-mixing matrices corresponds to one of the sources; and permuting the rows of the de-mixing matrices using the representation of the tv audio signal such that for the succession of time windows each row corresponds to the same source.

Some implementations may comprise converting the set of de-mixing matrices from the time-frequency domain to the time domain to determine a time domain demixing filter; and applying the time domain demixing filter to the speech audio signal in the time-domain to determine the least one audio signal component comprising the speech from the user and in which the acoustic tv audio is suppressed.

Some implementations may comprise constructing, from the demixing matrices, a multichannel filter to operate on the time-frequency data frames; applying the multichannel filter to said time-frequency domain data to determine de-mixed time-frequency data; and converting the de-mixed time-frequency data to the time domain to recover de-mixed time domain data for the least one audio signal component comprising the speech from the user and in which the acoustic tv audio is suppressed.

In some implementations, the processing the speech audio signal using semi-blind source separation further comprises reducing a time misalignment between the speech audio signal and the representation of the tv audio signal, prior to guiding the separation of the speech from the acoustic tv audio.

In some implementations, the time misalignment may be characterised by a small or significant time drift of the speech audio signal relative to the representation audio, and in examples the extent of the drift may not be known. Therefore, advantageously, by reducing the time misalignment, the reliability of the semi blind source separation process is improved, as the representation can be used more reliability to guide the separation of the speech from the user from the acoustic tv audio. Furthermore, reducing the time misalignment can improve the step of resolving the source ambiguity when samples are more closely aligned. It will be appreciated that the reduction in time alignment need not correspond to providing an absolute alignment between two signals. Merely for example, a time misalignment may be reduced from 200 ms to 10 ms.

In some implementations, reducing the time misalignment comprises converting each of the speech audio signal and the representation of the tv audio signal into time-frequency domain data, each comprising a succession of time-frequency data frames, determining a pair of frames that are a closest match, comprising determining that a data frame of the converted representation is a closest match to a component of a data frame of the converted speech audio signal, wherein the component corresponds to the second acoustic audio source comprising the acoustic tv audio, and indicating that the pair of frames relate to the same or nearby point in time.

In other words, the relative time alignment between the speech audio signal and the representation may be inferred from the audio alone. This obviates a need to provide a timestamp on the audio, and further obviates the need to have any shared word clock. Furthermore, the process of reducing time misalignment inherently accounts for any distortion to the tv acoustic signal once played from the playback device.

This can be done with very little or no a priori information about how misaligned (e.g., to what extent, such as an exact amount of misalignment in milliseconds) the samples are. In some examples, the component is an output source of the speech audio signal (i.e., the signal comprising a mixture of the first acoustic audio source and the second acoustic audio source) e.g. where the speech audio signal is split into multiple channels, each channel corresponding to a different acoustic source. The splitting into multiple channels can be performed by providing spatial filters in the form of demixing matrices.

In implementations, the closest match may be determined by finding a maximum of an objective function, such as a probability function, that the frame of the representation and the frame of the speech audio signal belong to the same point in time. A hidden Markov model may be used in this regard. The function may thus determine that the frame of the representation corresponds to the same or nearby point in time as the speech signal frame. The speech signal frame used in the determination may be a most-recent frame of the speech audio signal.

It will further be appreciated that a step-size used to determine how long each reference frame should last, in turn determines the accuracy that the time alignment can achieve. Generally, the step size used for the representation can be smaller than the step-size used for the speech audio signal. Merely for example, the step-size of the reference frame is around or under 20 ms, which can yield a time-alignment accuracy of +/−10 ms.

Some examples may comprise obtaining a representation of the tv audio signal comprises obtaining a reduced bandwidth representation of the tv audio signal. In example where the representation is of a significantly reduced bandwidth, the process of reducing a time misalignment may be inhibited to an extent. However, the representation may alternatively be provided with a timestamp to enable time alignment between the speech audio signal and the representation.

In some implementations, the processing of the speech audio signal comprises processing a digitized sample of the speech audio signal, and wherein the reduced bandwidth representation comprises a representation of an energy in the tv audio signal in a set of different frequencies at time intervals longer than an interval between the digitized samples of the speech audio signal.

In some implementations, obtaining the representation of the tv audio signal comprises sending representation of the tv audio signal from the first, playback device to the second, microphone device. The second, microphone device may comprise a set top box, and the sending may comprise sending over an HDMI audio return channel.

In some implementations the playback device does not have a priori knowledge of any acoustic component that will be picked up by the microphone, e.g., where the playback device is not the origin of an audio source. For example, where a TV is used as a remote communication means such as video conferencing. Means such as HDMI may include a distortion or time misalignment in the tv acoustic audio played by the playback device. Advantageously, however, the semi-blind source separation process can account for this misalignment without the need for a shared word clock.

Some implementations may comprise obtaining the representation of the tv audio signal at the second, microphone device, and sending the tv audio signal from the second, microphone device to the first, playback device.

In some implementations, the television system may be used as a video phone or video conferencing system, wherein the first, playback device provides an audio and video output for the video phone or video conferencing system, wherein the second, microphone device captures speech of a user of the video phone or video conferencing system, wherein the at least one audio signal component comprising the captured speech is provided for onward transmission to a remote video phone or video conferencing system station.

According to another aspect there is provided a method comprising: playing a first audio signal to generate first acoustic audio representing the first audio signal; capturing a second audio signal using a microphone, the second audio signal comprising a mixture of a first acoustic audio source comprising the first acoustic audio and a second acoustic audio source comprising a target audio; obtaining a representation of the first audio signal, wherein the representation of the first audio signal lacks a well-defined synchronization with the first audio signal; and processing the second audio signal to provide a processed audio signal, by using a semi-blind source separation process to separate the a target audio from the first acoustic audio and determine at least one audio signal component comprising the a target audio and in which the first acoustic audio is suppressed, wherein the semi-blind source separation process uses the representation of the first audio signal to guide the separation of the a target audio from the first acoustic audio.

For example, the target audio may be a user's speech. The user's speech may be captured for voice recognition purposes such as automatic speech recognition, or may be isolated for further processing in order to determine is a wake up word for a smart device has been spoken. Alternatively or in addition, the method may be applied to a voice conferencing system in which a speaker's voice is the target audio, and the first acoustic audio is a remote speaker's voice which is suppressed on the return path. Generally, the first acoustic audio may be referred to in the present disclosure an echo return, where the echo return is generally suppressed and/or rejected by the semi-blind source separation.

In some implementations, the semi-blind source separation process comprises converting the second audio signal to time-frequency domain data comprising a succession of time-frequency data frames for a succession of time windows, each having a plurality of frequency bands, determining a set of de-mixing matrices, one for each of the frequency bands, to apply to each time-frequency data frame to separate the a target audio from the first acoustic audio, and using the representation of the first audio signal to resolve an ambiguity between one or both of i) an allocation de-mixed sources to first acoustic audio, and ii) an allocation of de-mixed frequency bands to the sources.

According to a related aspect, there is provided a non-transitory storage medium storing processor control code to implement the method of any of the above disclosed methods.

According to a further related aspect, there is provided an audio-visual system comprising one or more processors configured to perform any of the above-disclosed methods.

### BRIEF DESCRIPTION OF THE DRAWINGS

These and other aspects of the invention will now be further described, by way of example only, with reference to the accompanying figures in which:

FIG. 1 shows an example arrangement for carrying out acoustic echo cancellation;

FIG. 2 shows a tv and set top box with which embodiments of the described system may be used;

FIG. 3 shows an example architecture for reference-guided blind source separation;

FIG. 4 shows an example method of providing a frame buffer from an input channel sample buffer;

FIG. 5 shows a flowchart for carrying out time alignment between a mic device input and a reference signal;

FIG. 6 shows an example spatial filter for architecture of FIG. 3;

FIG. 7 shows an example implementation of frame buffer management.

### DETAILED DESCRIPTION

Generally speaking, the present disclosure provides techniques for acoustic source separation by way of semi-blind source separation. Semi-blind source separation should generally be understood as reference-guided blind source separation (BSS) in the following disclosure. In broad terms, the present method will find application where a microphone and playback device are co-located (or part of the same device), where a common clock (e.g., a reference time) either cannot be shared between microphone and speaker, or it would be impractical to do so. Furthermore, the reference-guided BSS will find application even where a common word clock can be shared, but where there may be an inherent distortion applied to the speaker audio.

In one application, semi-blind source separation can be applied to a TV with a set top box which has a microphone array. In many scenarios, TVs synchronise an audio with video coming from the set top box to preserve lip-synchronisation on the TV. It is typical for TVs to do this with audio-to-video synchronisation (AV sync), by speeding up or slowing down the TV's audio word clock in order to keep the audio/picture synchronisation within the appropriate bounds. In such an application, it is possible to share a common word clock, however there may be no well-defined synchronization between the acoustic tv audio and an audio representation (e.g. the original tv audio signal). In some examples, the drift deliberately applied to the TV audio during AV sync can be as much as +90 ms or −185 ms relative to the video.

The above tolerances may keep the synchronisation between audio and video acceptable for a viewer, however, such variations would render the common clock unusable and therefore traditional AEC solutions would be ineffective. Therefore, in examples where a TV and set top box is used as a video/voice conferencing system, or where the set top box attempts to understand a voice command of a user (over audio playing from the TV), AEC would not be suitable for capturing and/or isolating a user's voice.

A further limitation of traditional AEC, in general, is that it does not deal well with distortion in the loudspeaker/playback path as this is not predictable with a linear filter.

Generally speaking, BSS may be used as a solution for AEC without any reference to guide the separation. However, in preferred examples, it is desirable to be able to reliably identify which extracted source corresponds to the loudspeaker. Further in this regard, it is preferable to have a system arranged to react quickly to speaker noise after an extended period of salience, such that the system can quickly begin rejecting the speaker audio.

Consistent with the above limitations, we disclose methods which take advantage of the constant spatial location between a playback device relative to the microphone array to reject sounds from the speaker of the playback device. The rejection of the playback device's ‘echo’ is achieved by utilising a representation of playback audio signal to enable reference-guided blind source separation of a user's speech. Advantageously, this arranging also rejects any distortion in the speaker audio, as this distortion is merely part of the speaker's audio from the perspective of the BSS process.

In general, the semi-BSS approach separates the acoustic sound field (e.g., all sound received at the microphone array) into estimates of the individual sources in the sound field (the extracted sources). Multiple methods are suitable for blind source separation in implementations of the described system, including Independent Component Analysis (ICA), Independent Vector Analysis (IVA) and Local Gaussian Mixture Models (LGM), where each method comprises designing a spatial filter from the statistics of the data, rather than from geometric considerations. Consequently, as mentioned, no a priori knowledge of the exact locations of any sound source, or the position of a microphone relative to a speaker of the playback device, is needed.

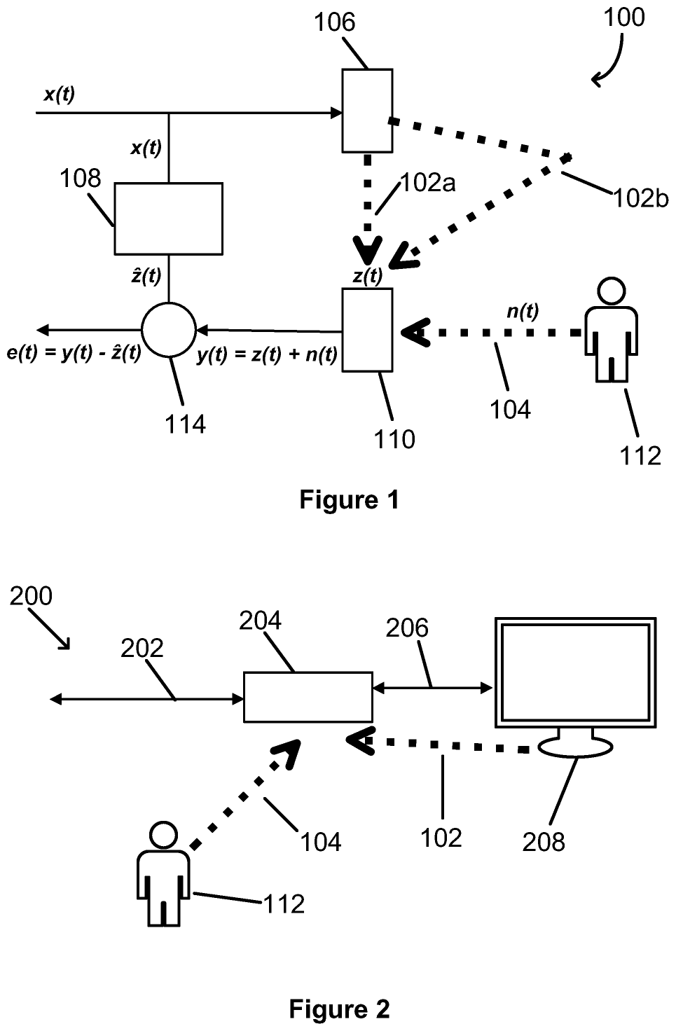

FIG. 1 shows a general example of a system 100 in which AEC is applied without reference guided blind source separation, merely for context. An audio signal, x(t), is transmitted towards a loudspeaker 106, where the loudspeaker plays the signal as an acoustic audio 102. The acoustic audio is picked up directly 102a by a microphone device 110, and may also be picked up in as a secondary acoustic signal 102b, e.g., due to reflections/echo of the room. Thus, the microphone device picks up an altered version, z(t), of the original audio signal x(t). In the present system, a user 112 is also present, who wishes speak into the microphone device 110 to transmit some speech audio 104, n(t). The total acoustic audio signal picked up by the microphone is combination of the speaker audio 102 and user's speech 104 audio: y(t)=z(t)+n(t).

The combined audio, y(t), is initially thus transmitted back along the return path, at which point an implementation 108 of AEC attempts to predict the altered version of the speaker audio, z(t), that has been picked up. The prediction of the speaker audio picked up by the microphone device is \hat{z}(t), which is then subtracted 114 to return an estimation, e(t), of the original speech audio, n(t), spoken by the user. Generally, the speaker device 106 and microphone device 110 can be separate, or part of the same device. Furthermore, the implementation of AEC 108, 114 can further be part of the same device as the microphone and speaker, or a separate, or even remote (wireless) unit.

However if there is any timing discrepancy between the loudspeaker 106 and the microphone device 110, the signals y(t) and \hat{z}(t) will not have a consistent value of t. The subtraction e(t)=y(t)−\hat{z}(t) is generally only useful if the loudspeaker 106 and the microphone 110 share a clock. With some existing approaches, without a shared clock the signals need to be synchronised to well within one sample time, with the tolerance for misalignment likely of the order of 5 μs, which can be very challenging to achieve in practice.

There are also several applications that such a device or devices as shown in the system 100 can be used for. Some examples are:
Voice Conferencing, in which the AEC device attempts to prevent the echo (e.g. a physical echo/reflection of the acoustic audio 102b, and/or a remote caller's own voice 102a) getting back to a remote caller;
Smart device, in which the AEC captures/isolates a user's speech from background noise and any audio being played by the smart device, for further processing such as in Automatic Speech Recognition (ASR) and/or response to a voice command. This provides robust voice control of the smart device that works even in the presence of playback audio, background noise, and even multiple people's voices;
Hearing Assistance. Such a device helps solve or improve the “cocktail party problem”, e.g. where people with mild hearing loss lose the ability to understand speech in the presence of background noise. In such an application, the device may use BSS to separate any sources of audio and transmit a source of interest to the user via an ear bud or hearing aid. Therefore, it is advantageous to reduce or eliminate any residual interference/distortion from the user's own voice. Modern hearing aids and ear buds often have microphones on them, where the audio from this mic can be routed back to the hearing assistance device. Thus, a user's own voice can be used as a reference (e.g. audio representation) to help reduce or eliminate any interference of a user's voice.

In the scenario of voice conferencing or a smart device, traditional AEC can be applied if there is a reliable word clock that can be used to synchronise the acoustic signals. However, implementations of the described system are directed towards solving the problem where no reliable word clock exists, or no well-defined synchronization can be obtained. In the example of a hearing assistance/hearing aid, a word clock is simply not practical and would be non-trivial to implement, therefore reference-guided BSS can beneficially be applied. Generally speaking, reference-guided BSS is advantageous in any example wherein playback means and a microphone are in disparate devices (and where defining a synchronisation would be impractical or impossible).

FIG. 2 shows a specific embodiment system 200 of a smart device 204 in combination with a TV 208, that may also be used for voice conferencing systems. The smart device 204 may receive an external signal along a transmission cable 202, which may comprise a tv aerial/satellite and the like, and along which the smart device 204 can transmit a return audio when used as e.g. a voice conferencing system. The TV 208 may be connected to the smart device 204 via any kind of suitable audio/video transmission means, for example, HDMI 206. The TV 208 may be a smart TV having its own microphone device, or the smart device 204 may be some form of set top box having a microphone device. Generally, the microphone device may comprise a plurality of microphones, e.g., two or more, consistent with the detailed embodiments of the methods as described below. However, the following method does not preclude embodiments having only a single microphone.

In such an example comprising an HDMI connection 206, the audio signal may be adjusted via ‘AV sync’ in order to maintain aesthetic correspondence to the video for a viewer. Therefore, in system 200, the audio 102 received back at the device 204 may be distorted relative to the original signal received via 202. Thus, there is no well-defined synchronisation between a representation of the audio (i.e. derived from the original signal x(t)) and the acoustic audio 102 picked up by the microphone device in the smart device 204.

In the embodiment shown, the TV 208 has its own speakers which produce acoustic audio 102 captured by the smart device 204. AEC implementation 108, 114 such as reference-guided BSS may thus be implemented in the smart device 204.

Specifically, examples of the present disclosure can be characterised in three embodiments, amongst others possible example arrangements that would occur to the skilled person. The three embodiments specified below relate to the direction of playback audio between a ‘microphone device’ and a playback device (for example comprised in the TV 208 in the example system 200). In preferred embodiments, the microphone device comprises a plurality of microphones, for example a mic array comprising 2, 4, or more microphones. It will be understood by the skilled person that some example implementations will use one or other of the following modes exclusively, and some implementations may switch between them as appropriate.
1. The mic device sends playback audio to the playback device over a link that is not audio clock synched (such as smart set top box playing over HDMI to a TV)
2. The multi-mic device receives playback audio from the playback device over a link that is not audio clock synched (such as a smart set top box where the TV is sending the playback audio to the multi-mic device over an HDMI's Audio Return Channel. This may be used when the TV is playing audio from an alternative source like a USB stick or similar.)
3. The multi-mic device is the same as the playback device (such as when playback distortion is a limiting factor)

In all these of the above cases, traditional AEC techniques are of limited applicability or ineffective in capturing a user's speech.

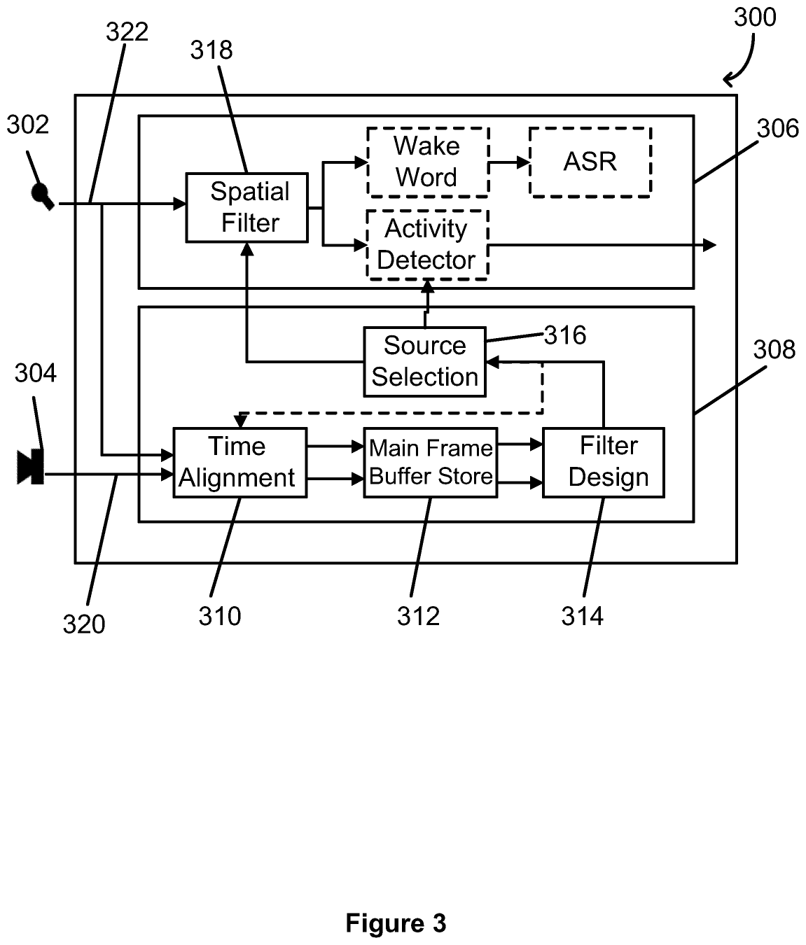

FIG. 3 illustrates an example system 300 generally in accordance with the second example above (i.e., where the microphone device receives playback audio). Other modes may use the general architecture and individual processing segments as shown, where the routings of the audio signals may vary.

The system comprises a signal path unit 306 and an analysis unit 308, in addition to a microphone device 302 and a loudspeaker/playback device 304. Microphone device 302 thus transmits a mic signal 322 comprising all acoustic audio including any audio produced by playback device 304, e.g. the mic signal 302 may be consistent with y(t) of FIG. 1 in some example. In addition to producing acoustic audio (not shown), the playback device sends a reference signal 320 (otherwise referred to as an audio representation in the following disclosure) of the audio for use in guiding the semi-BSS process.

In the analysis unit 208, both the mic signal 322 and the reference 320 are processed at a time alignment unit (described below in greater detail), before being stored in a main frame buffer 312, and passed to a filter design 314 used to inform the blind source separation process. These aspects are described in detail below, in accordance with example implementations of the system. In general, the analysis unit designs the source separation filters from the mic signal and the reference audio signal. It processes the audio as frames, where each frame is defined in this disclosure as a contiguous block of audio samples.

Source selection 316 then occurs using the filter designed at 314, before being passed to a spatial filter used to capture the user's speech. Generally, the signal path unit applies the source separation filters to the multi-mic audio for the intended purpose. Optionally, once the user's speech has been captured, it may be transmitted for further processing, for example, to determine whether a ‘wake word’ has been spoken (e.g., to initiate some process in a smart device), and the process the captured speech using automatic speech recognition (ASR). It will be apparent to the skilled person however that these are merely examples implementations of a smart device, and are not required for any aspect of the present disclosure.

Furthermore, in some examples, the time alignment unit is optional. For example, the reference signal and mic audio may already be time-aligned. Generally speaking, the time alignment is optional in examples where the reference audio is timestamped by some external device. For example, in examples where the reference is a low quality or partial representation of the playback audio (for example, a compressed signal) it may be preferable to timestamp the playback audio, as time alignment processing may not be as reliable with a compressed reference signal 320.

In some example implementations, the Filter Design 314 component can cope with up to 30 ms misalignment between the mic signal 302 and the reference frames of the reference signal 310. The Time Alignment component aligns the reference frames with the mic device frames to achieve this degree of alignment accuracy. The main frame buffer store component 312 stores the mic signal 322 frames with their respective aligned reference frames. This 30 ms misalignment tolerance is far greater than the 5 μs misalignment tolerance provided by some prior art systems.

The filter design component 314 uses the frames in the main frame buffer store 312 to design a set of spatial filters that separate the mic audio signal into the separate sources (for each respective source picked up by the microphone device 302). Each spatial filter will extract either an echo return source, or one of the other (target) sources in the scene. In the following disclosure, a target source is used to refer to audio of interest to a smart device, e.g. a user's speech, and any other audio sources are referred to as an echo return source (where, as mentioned, the echo return signals may merely comprise a remote speaker's voice). Accordingly, target filters and echo return filters are defined, which operate on the target source and echo return sources, respectively. The aligned reference audio frames are used to identify the echo return filter. In preferred embodiments, the aligned reference frames may also be used to guide the filter design 314 component to improve the amount of echo rejection in the target filter(s).

In general, the source selection 316 component decides what to do with the source separation filters. By default, it discards the echo return filter. It may also select a subset of the target filters. For example, in a video conferencing application, only the target sources that correspond to faces detected in the video need be extracted in the signal path. The application may not require the ability to separate the target source(s) at all, in which case the target filters can be combined into a single filter.

The signal path unit 306 consists of the Spatial Filter component 318, and optionally a variety other components depending upon the application. The Spatial Filter 318 components applies the filters to mic audio signal 322 to extract the selected source(s) (i.e., selected in the analysis path at 316).

In a Video Conferencing example, some form of Voice Activity Detection component might be used to dynamically follow the dominant speech source from those chosen in the Source Selection component. This makes use of the fact that in most conversations there is generally only one person talking at a time.

Alternatively, in a smart device example, each selected source(s) could be passed to a ‘wake word’ detector component. Whichever source triggers a wake word detection is then passed on to the Automatic Speech Recognition engine. The ASR engine may could be in the smart device system 300 as shown, or may be in a remote device, such as in a remote server or in the cloud. Generally, smart devices such as a set top box 204 shown in FIG. 2 may support any one of, or a combination of, all of these applications.

### Detailed Example Method

Preferably, the analysis path operates in the time-frequency domain. The microphone signal 322 audio and the reference signal 320 audio may be converted to the time-frequency representation using a short time Fourier transform (STFT), with one STFT per channel (for example, one channel per microphone, where the mic device comprises multiple microphones) of input audio.

Furthermore, in general, examples of the method may pre-process acoustic data to reduce an effective number of acoustic sensors to a target number of “virtual” sensors, in effect reducing the dimensionality of the data to match the actual number of sources. Therefore, the number of channels may not correspond to the number of microphone in the microphone device. This may be done either based upon knowledge of the target number of sources or based on some heuristic or assumption about the number of likely sources. The reduction in the dimensionality of the data may be performed by discarding data from some of the acoustic sensors, or may employ principal component analysis

In detail, each STFT is performed by accumulating the input audio in a sample buffer. The sample buffer can be in the range of around 30 ms to 250 ms long, although other buffer sizes are possible. Over a set of intervals, which may be periodic intervals, a windowed fast Fourier transform (FFT) is taken of the sample buffer and inserted into a frame buffer. Many windowing functions are suitable for this purpose, e.g. Hamming or Blackman-Harris, however preferred exampled use a Hanning (i.e., Hann) window function.

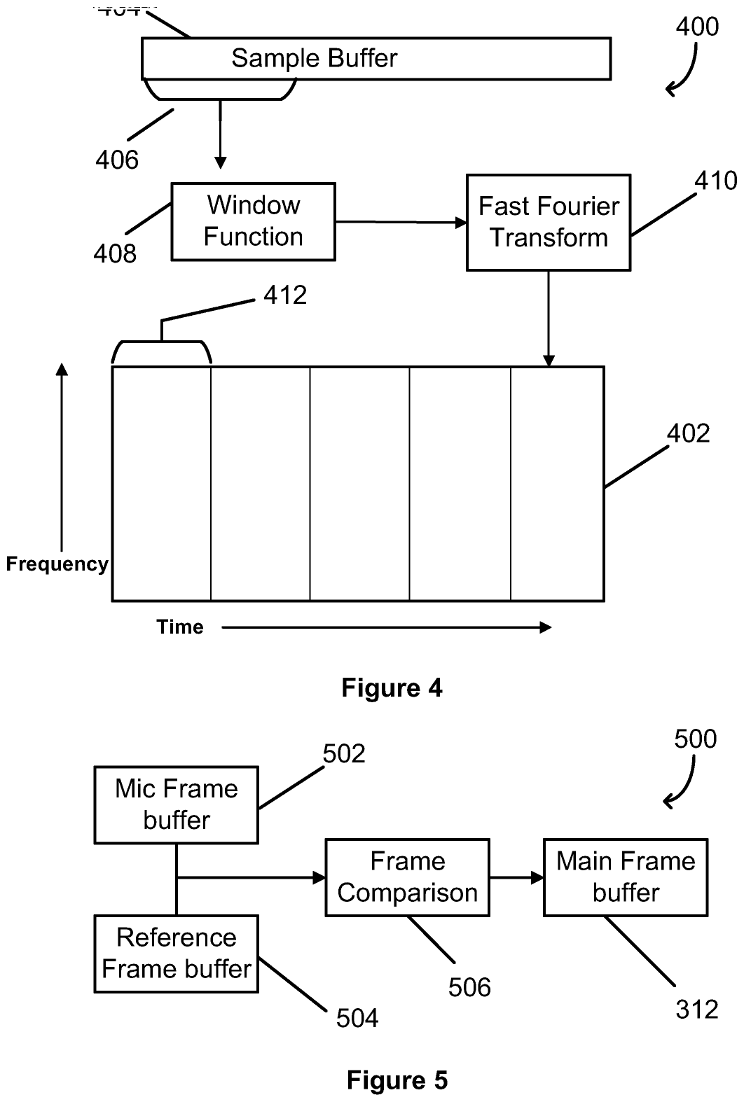

FIG. 4 illustrates an example method 400 of generating a set 402 of frames 412 of the mic signal 322 audio in the time-frequency domain from the mic sample buffer 404, by selecting an interval for the window function, applying the window function 408 and an FFT 410.

The interval of the window function may be called the step-size. For the mic signals 322, the step-size is preferably around half the window size 406 such that there is a 50% overlap (not shown) between the resulting successive frames 412. For example, in FIG. 4, the interval could be illustrated as the stride length taken along the sample buffer by the window 406 upon each successive Fourier transform. However, it will be understood that this is a preferred example, and other example implementations can use different step-sizes, e.g. the step size can be chosen such that successive frames have gaps between, which, beneficially, improves computational (e.g. processing time) and memory efficiency.

### Time Alignment

The processing of the reference signal is generally different, as this depends upon the method used in the Time Alignment 310 component. There are various options for the Time Alignment, depending upon how much information is available regarding the timing offset/drift between the mic audio signal 322 and the reference signal 304.

In many examples, there may be very little external information about the relative drift between the reference and mic signals. In this case, the time offsets are determined from the data. Generally, a multi-channel frame buffer is generated for the mic frames, and another frame buffer is generated for the reference frames.

FIG. 5 illustrates a general flowchart 500 for the time alignment, comprising obtaining the microphone frame buffer 502 and the reference frame buffer 504 (for example using method 400 as described above), comparing the two frames in a frame comparison step 506, and generating a Main frame buffer 312, as indicated in FIG. 3.

The length of the mic frame buffer 502 is designed to be large enough to cover any timing advance (e.g., drift/offset) of the mic samples relative to the reference. Usually there will be no significant advance, and in such examples the mic frame buffer is able to store only one frame.

The reference frame buffer is generally created with a smaller step-size 412. This determines the maximum accuracy that can be achieved in aligning the reference frames to the multi-mic frames. In preferred examples, the step-size is under 20 ms, which gives a maximum accuracy of around ±10 ms.

On each complete mic frame, the Frame Comparison module 506 determines the reference frame that best matches the last frame in the multi-mic frame buffer. In some scenarios, a match cannot be determined because the reference sample audio is too quiet. Generally, the mic frame and the matched reference frame (if it can be determined) are stored in the Main Frame Buffer 312.

The following definitions are used to describe the various frame buffers and their indexing
k is the frame number of the oldest frame in the mic frame buffer,
l is the index of a frame in the reference frame buffer,
f is a frequency index in a frame,
c is a channel index in a multi-channel frame (i.e., where the microphone device comprises multiple microphones),
x_{kfc} is the mic STFT data for the time-frequency-channel point [symbol] k, f, c [symbol] ,
z_{lf} is the reference STFT data for the index-frequency point [symbol] l, f [symbol] .

In this document, the convention is used that dropping a subscript indicates a vector, so x_{kf} is the mic frame data for time-frequency point [symbol] k, f [symbol] as a vector over each channel.

Use is made of the spatial filters created by the Filter Design 314 component. The spatial filters are represented in the frequency domain by the demixing matrices W_{f}, one for each FFT frequency. In the time-frequency domain the spatial filters calculate the output source estimate y_{fk} by the transformation

y_{fk}=W_{f}x_{fk}.

One of the channels in the output source estimate (y_{kc}) should contain a separated estimate of the echo return, which in turn is a related to the reference frame data zₗ by an arbitrary room transfer function (RTF, the estimation of which is described below in detail). In broad terms, the Frame Comparison module 506 determines the reference frame index l and the output source estimate channel c that give the most likely match of y_{kc} to zₗ over all frequencies.

### Prediction Step

The following further definitions are provided for the present disclosure:
Y_{kfc}=ln|y_{kfc}|², the extracted source log-power at time-frequency point [symbol] k, f [symbol]
Z_{lf}=ln|z_{lf}|², the reference log-power at time-frequency point [symbol] l, f [symbol]
Let lₖ be an index into the reference frame buffer to associate with frame number k.
Let cₖ be an output source that is associated with the echo return (e.g., any channel not containing a user's speech of interest).
Let sₖ be the pair formed by [symbol] lₖ, cₖ [symbol]
Let g_{f} be the RTF expressed as a log-power gain

A Hidden Markov Model (HMM) is subsequently used to update the most likely matching reference frame of the reference frames zₗ, on each mic frame update. In general, a HMM has a hidden state that has a finite set of possibilities. In the present case, the set of states is the set of possible values of sₖ.

The HMM process performs a prediction step and an update step for each frame k.

It is assumed that g_{f} is known, and that the prior probability distribution p(sₖ₋₁|Yₖ₋₁, Yₖ₋₂ . . . , g) is also known.

The general Markov assumption is then applied that each state is dependent on the immediately preceding state. In the present case, the assumption is that that the index and channel only depend upon the previous index and channel, which can be expressed as the transition probabilities p(sₖ|sₖ₋₁). Bayes rule is then applied to marginalise over to sₖ₋₁ to get the index probabilities given the previous observations:

$$p ( {s}_{k} \vert {Y}_{k - 1} , {Y}_{k - 2} , ⋯ , g ) = {\sum }_{{s}_{k - 1}} p ( {s}_{k} \vert {s}_{k - 1} ) p ( {s}_{k - 1} \vert {Y}_{k - 1} , {Y}_{k - 2} , ⋯ , g ) .$$

It can be assumed that the state transition probabilities are independent for the index and the channel, so

p(sₖ|sₖ₋₁)=p(lₖ|lₖ₋₁)·p(cₖ|cₖ₋₁).

A good model for predicting the reference index is lₖ=lₖ₋₁+ΔT−ΔNₖ+eₖ. ΔT is the number of reference frames per mic frame, due to the difference in FFT step-sizes used for the mic frames and reference frames as described above. ΔNₖ is the number of frames removed from the reference frame buffer since the last mic frame, where it is noted that ΔNₖ can vary due to e.g., clock drift and timing jitter. eₖ is used to define the random drift.

Rearranging gives:

eₖ=lₖ−lₖ₋₁−ΔT+ΔNₖ,

p(lₖ|lₖ₋₁)=p(eₖ).

Any suitable probability distribution function (PDF) for p(eₖ) may be used, such as a triangular distribution over a small range, or a normal distribution with zero mean. The variance of the distribution should, in preferred examples, match the expected variability in eₖ. This variance is generally quite low, e.g. around 0.1.

The prediction for cₖ is relatively straightforward as the echo return should not jump between output source estimates, therefore in general cₖ=cₖ₋₁. In other examples however, a small likelihood of a jump may be accounted for.

### Update Step

Having calculated the prediction step, an update is performed using the latest observations.

Assuming that the observation likelihood p(Yₖ|sₖ, g), is known, the Markov assumptions are invoked again to yield:

$$p ( {s}_{k - 1} \vert {Y}_{k - 1} , {Y}_{k - 2} , ⋯ , g ) = p ( {Y}_{k} \vert {s}_{k} , g , c ) \cdot p ( {s}_{k} \vert {Y}_{k - 1} , {Y}_{k - 2} ⋯ , g ) ,$$

$$p ( {s}_{k} \vert {Y}_{k} , {Y}_{k - 1} ⋯ , g ) = \frac{p ( {s}_{k} \vert {Y}_{k - 1} , {Y}_{k - 2} ⋯ , g )}{{Σ}_{{s}_{k}} p ( {s}_{k} \vert {Y}_{k - 1} , {Y}_{k - 2} ⋯ , g )} .$$

It is assume that the observations are independent across frequency, therefore

$$ln p ( {Y}_{k} \vert {s}_{k} , g ) = {\sum }_{f} ln p ( {Y}_{fk} \vert {s}_{k} , {g}_{f} ) .$$

For the per-frequency PDF p(Y_{fk}|sₖ, g_{f}) a variant of the student-t distribution is used for log-powers:

sₖ↔ [symbol] l, c [symbol] ;

ln p(Y_{kf}|sₖ, g_{f})↔ln p(Y_{kfc}|l, g_{f});

ln p(Y_{kf}|sₖ, g_{f})=α_{f}(Y_{kfc}+Z_{lf}+g_{f}−2 ln(exp Y_{kfc}+exp(Z_{lf}+g_{f})))+ln Γ2α_{f}−2 ln Γα_{f}

The ln Γ terms are constant terms that do not affect the outcome of the matching algorithm. The notation [symbol] indicates equality up to a constant offset.

The shape parameter α_{f} can be used as a frequency weighting in the HMM.

### Modelling Interference

The output source estimates will have some residual interference, which is not modelled in the per frequency PDF. The expected interference power may be modelled as

$${σ}_{Ikf} = λ {\sum }_{c} {\vert {x}_{kfc} \vert}^{2} .$$

The value of λ is typically 0.1 to 0.01 representing about 10 to 20 dB of interference reduction. A further noise term could be added here if a reasonable estimate of the background noise power is known.

Z′_{lkf} defines the predicted amount of the reference log-power that appears at the echo-return output. The model of additive noise/interference gives

Z′ₗ_{ₖ}_{f}=ln(σ_{Ikf}+exp(Z_{lf}+g_{f}))

Alternatively, this can be approximated by

Z′ₗ_{ₖ}_{f}=max(ln σ_{Ikf}, Z_{lf}+g_{f})

The observation log-likelihood is then

ln p(Y_{kf}|sₖ, g_{f}) [symbol] α_{f}(Y_{kfc}+Z′ₗ_{ₖ}_{f}−2 ln(exp Y_{kfc}+exp(Z′ₗ_{ₖ}_{f}))).

This helps to mitigate against small reference signals getting lost in any noise/interference.

The objective is thus to choose the reference frame and channel that maximises p(sₖ|Yₖ, Yₖ₋₁ . . . , g), to associate with the multi-mic frame:

$${\hat{s}}_{k} ← {argmax p}_{{s}_{k}} ( {s}_{k} \vert {Y}_{k} , {Y}_{k - 1} ⋯ , g )$$

Additionally, an indication can be given as to whether it is a good match by comparing the probability p(ŝₖ|Yₖ, Yₖ₋₁ . . . , g) against a threshold.

ŝₖ represents the pair [symbol] \hat{l}ₖ, ĉₖ [symbol] , which may be used in the next section.

### Estimating the RTF

If it is assumed that there is a paired frame k↔\hat{θ}ₖ, it is possible to use a gradient update step on the log-likelihoods to get

$$∇ ln p ( {Y}_{k} \vert {\hat{l}}_{k} , g , {\hat{c}}_{k} ) = {α}_{f} ( \frac{exp {Y}_{fk {\hat{c}}_{k}} - exp ( {Z}_{f {\hat{t}}_{k}} + {g}_{f} )}{exp {Y}_{fk {\hat{c}}_{k}} + exp ( {Z}_{f {\hat{t}}_{k}} + {g}_{f} )} )$$

Or, if interference is being modelled, then

$$∇ ln p ( {Y}_{k} \vert {\hat{l}}_{k} , g , {\hat{c}}_{k} ) = \{ \begin{matrix}{α}_{f} ( \frac{exp {Y}_{fk {\hat{c}}_{k}} - exp ( {Z}_{f {\hat{t}}_{k}} + {g}_{f} )}{exp {Y}_{fk {\hat{c}}_{k}} + exp ( {Z}_{f {\hat{t}}_{k}} + {g}_{f} )} ) & ∀ {Z}_{f {\hat{t}}_{k}} + {g}_{f} \geq ln {σ}_{Ikf} \\ 0 & ∀ {Z}_{f {\hat{t}}_{k}} + {g}_{f} < ln {σ}_{Ikf}\end{matrix}$$

a gradient step size μ (which is different to the FFT step size) can be used to yield

g_{f}←g_{f}+μₖ·∇ ln p(Yₖ|\hat{l}ₖ, g, ĉₖ)

where

−α_{f}≤·∇ ln p(Yₖ|\hat{l}ₖ, g, ĉₖ)≤α_{f}

μₖ·α_{f}·10/ln 10 thus defines the maximum slew rate as dB's per mic frame.

μₖ can be subsequently reduced as the updates proceed and greater confidence in the RTF estimate is obtained:

$${μ}_{k} ∝ \frac{{μ}_{0} \cdot {k}_{half} + {μ}_{∞} \cdot k}{{k}_{half} + k}$$

is used, where k_{half} is a constant that determines how quickly the step size reduces and μ₀, μ_{∞} determine the limits on the step size at k=0 and k=∞ respectively.

### Time Alignment Output

The Time Alignment 310 passes the following information on to the Main Frame Buffer Store 312 or each mic frame.
The mic frame data, xₖ
The predicted log power for the reference Z′_{\hat{l}}_{ₖ}_{f}.
Whether this is a good match

### Alternative Time Alignment

As mentioned above, sometimes external information is available about the timing offsets between the reference signal and mic signal samples, which in some examples may be robust enough to dispense with the HMM described above for the purposes of Time alignment.

This may be the case, for example, if the mic and the reference audio use a common word clock, or if there is an external mechanism that can provide us the timing offsets, e.g. by providing a timestamp(s) on the reference audio signal.

In either case, it is possible to lengthen the sample buffers used in the STFTs appropriately to accommodate the maximum possible time advance and delay. It can then be determined where about in the reference sample buffer to take the FFT for the aligned reference frame. However, the output of the time alignment should still be in conformity with the interface for the Main Frame Buffer Store as described above. Therefore, preferably the RTF is estimated to provide an indication if the match is good. This estimation can be done using a cut down version of the algorithms derived earlier.

### Main Frame Buffer Store

A frame buffer store may use an importance metric to overwrite unimportant frames when updating the frame buffer with new frames. This importance metric is described below in detail, however, it will be understood is not a requirement for the functioning of reference-guided BSS in general.

This means that the frames in the Main Frame Buffer store are not contiguous, so the set K is used to mean the set of frames in the Main Frame Buffer Store.

In the reference-guided version of BSS, the frame buffer store is extended to include the aligned reference frames. Further, the correspondence between mic frames and reference frames is maintained. So, the process ensures that corresponding mic and reference frames are overwritten when updating the frame store with a new mic and reference frame. The aligned reference frame is thus defined in terms of its rms power

z_{kf}=\sqrt{exp(Z′_{\hat{l}}_{ₖ}_{f})}

It should be appreciated that use of the rms power is optional, however, in some embodiments it is chosen because it is dimensionally consistent with the distribution used in the BSS.

One of the issues with echo cancellation is that the reference may be quiescent for extended periods, such as when the loudspeaker is muted or off. However, it is desirable to be able to remove the loudspeaker from the other source estimates as soon as it awakes. This can be done by using the reference in the importance metric, thus ensuring that useful reference frames are less likely to be considered unimportant, and therefore mitigating them being overwritten.

The generalised power Σ_{f}z_{kf}^{p} may be used as a simple measure of the usefulness of a reference frame. Generally, p=1 is used for the total abs and p=2 for the total power.

A more appropriate measure is the normalised frame powers. An intermediate term u_{fk} and a value mₖ may be defined as

$${u}_{ft} = \frac{{z}_{kf}^{p}}{{Σ}_{k ∈ K} {z}_{kf}^{p}} \\ {m}_{k} = {\sum }_{f} {u}_{kf}$$

The value mₖ indicates the activity in the reference frame, and can be used in the performance metric. In this manner the frame buffer store can always contain information about the reference channel.

For further improved immediate rejection of loudspeakers, the frame buffer store can be saved to persistent (e.g., non-volatile storage) storage before power down, such that it can be reloaded upon power up, to ensure reliable early rejection of the reference.

### Filter Design

ML-ICA is described in detail below, along with a stochastic approach with an importance metric, all contained in an STFT framework.

From such an application of ML-ICA, the ML-ICA equations transcribed into our notation are

$${y}_{kf} = {W}_{f} {x}_{kf} \\ ln p ( {x}_{f} ⋁ {W}_{f} ) = {\sum }_{k ∈ K} ln p ( {x}_{kf} ⋁ {W}_{f} ) \\ ln p ( {x}_{kf} ⋁ {W}_{f} ) {=}^{Δ} ln {detW}_{f} {W}_{f}^{H} - \vert {y}_{kf} \vert {=}^{Δ} ln {detW}_{f} {W}_{f}^{H} - {\sum }_{c} \vert {y}_{kfc} \vert$$

First, a time-frequency-channel weighted version of these ML-ICA equations is introduced. The idea of a time-frequency-channel varying weighting θ_{kfc} is also introduced such that

$$ln p ( {x}_{kf} ⋁ {W}_{f} , θ ) = ln {detW}_{f} {W}_{f}^{H} - {\sum c}_{} {θ}_{kfc} \vert {y}_{kfc} \vert$$

Following the same development described below in relation to ML-ICA, the Wirtinger derivative can be provided as

$$∇ ln p ( {x}_{f} \vert {W}_{f} , θ ) = {\sum }_{k ∈ K} ( 2 {W}_{f}^{- H} - {\sum }_{c} {θ}_{kfc} sign ( {y}_{kfc} ) {x}_{kfc} )$$

The natural gradient follows the same set of equations but with the new ∇ ln p(x_{f}∨W_{f}, θ)

$${W}_{f} ← {W}_{f} + \frac{{μ}_{k}}{2 \vert K \vert} \cdot ∇ ln p ( {x}_{f} ⋁ {W}_{f} , θ ) \cdot {W}_{f}^{H} {W}_{f} \\ ( ( 1 + {μ}_{k} ) I - \frac{{μ}_{k}}{2 \vert K \vert} {\sum }_{k ∈ K} ( {θ}_{kf} ∘ sign {y}_{kf} ) {y}_{kf}^{H} ) {W}_{f}$$

Where ∘ represents element-wise multiplication of two vectors. This can be rewritten as using an intermediate variable G

$$G = \frac{1}{2 \vert K \vert} {\sum }_{k ∈ K} ( {θ}_{kf} ∘ sign {y}_{kf} ) {y}_{kf}^{H} \\ {W}_{f} = ( ( 1 + {μ}_{k} ) I - {μ}_{k} G ) {W}_{f}$$

Provided the definitions of ∇L and G above, methods described in published PCT application WO 2019/016494 A1 (International Application No. PCT/GB2017/052124), pages 20-33, can readily be adapted to time-frequency-channel weighted version as described in the present disclosure.

In some implementations, for dimensional consistency, the frequency-time-channel weights can be normalised such that they average to 1 over time

$$\frac{1}{\vert K \vert} {\sum }_{k ∈ K} {θ}_{kfc} = 1$$

Consistent with the techniques described above, it can be shown how the time-frequency-channel weights can be used to solve the AEC problem using reference-guided BSS even when there is no common word clock.

In general, z_{kf} can be used in two ways to inform the time-frequency weighting. The two embodiments may be used separately or together. It is found, however, that the best results are obtained when both are used together. Nevertheless, either on their own lead to improvements in the use of BSS to remove the loudspeaker signal.

Without loss of generality, an attempt is made to extract the echo return onto the first output source estimate (c=0).

The first method is to extend the probabilistic model used in the BSS equations to include a scale parameter on the “echo” output

$${θ}_{k f 0} ∝ \frac{1}{{z}_{k f}}$$

The second method is to use θ_{kfc} to implement a penalty term to penalise correlations between the reference and the other outputs. This can be a regulariser or a Bayesian prior, for example. For example, we can define the absolute correlation for channel c as

$${ψ}_{f c} = \frac{K}{{\sum }_{k ∈ K} {z}_{k f}} {\sum }_{k ∈ K} {z}_{k f} \vert {y}_{k f c} \vert$$

Implementing this as regularisation term with coefficient β gives

$$lnp ( {x}_{f} ⋁ {W}_{f} , z ) = {\sum }_{k ∈ K} lnp ( {x}_{k f} ⋁ {W}_{f} ) - β {ψ}_{f c}$$

Which can be rearranged to show that

$$lnp ( {x}_{f} ⋁ {W}_{f} , z ) = {\sum }_{k ∈ K} ( lndet {W}_{f} {W}_{f}^{H} - {\sum }_{C} \vert {y}_{k f c} \vert - β {\sum }_{c > 0} \frac{K {z}_{k f}}{{\sum }_{k ∈ K} {z}_{k f}} \vert {y}_{k f c} \vert )$$

Using a regulariser to penalise the absolute correlation in this way is equivalent to choosing a time-frequency-channel weight for c>0

$${θ}_{k f c} = 1 + β \frac{K {z}_{k f}}{{\sum }_{k ∈ K} {z}_{k f}}$$

This regulariser is applied to the channels that are intended not to contain the “echo return”. In preferred embodiments, these weights are still normalised, and the following is used

$${θ}_{k f c} ∝ 1 + β \frac{K {z}_{k f}}{{\sum }_{k ∈ K} {z}_{k f}}$$

This gives an overall definition of the time-frequency-channel weights as

$${θ}_{k f c} ∝ \{ \begin{matrix}\frac{1}{{z}_{k f}} & : c = 0 \\ 1 + β \frac{K {z}_{k f}}{{\sum }_{k ∈ K} {z}_{k f}} & : c > 0\end{matrix}$$

Further advantageously, these methods output the echo on known channels, where this knowledge can be used in solving the frequency permutation, which can result in more efficient CPU and less permutation.

The Filter Design component 316 then applies an inter-frequency permutation and scaling algorithms, as outlined below. Once these are applied, the filters are passed back to the Time Align component 310 to update the values of the demixing matrix W_{f}.

### ML-ICA

Maximum likelihood independent component analysis, ML-ICA is a frequency-domain ICA algorithm that can be applied to the problem of blind source separation. We will describe techniques which provide improved performance and reduced computational complexity in the context of this problem.

ML-ICA operates in the STFT domain on the multi-channel time-frequency observations x_{ft} to calculate a set of de-mixing matrices W, one per frequency. Here multi-channel refers to the multiple (acoustic) sensor channels, typically microphones, and “frequency” is short for “frequency channel”. The multi-channel observations are stored in a T×F frame buffer X. As new frames are received, the frame buffer can be updated and the de-mixing matrices re-calculated.

Thus for each frequency, ML-ICA designs a demixing matrix W_{f} such that the separated outputs are given by

$${\underline{y}}_{ft} = {W}_{f} {\underline{x}}_{ft}$$

The de-mixed outputs represent the original audio sources up to a permutation and scaling ambiguity which may be solved separately.

The ML-ICA log likelihood for each frequency is given by

$$L ( {X}_{f} ; {W}_{f} ) = {\sum }_{t = 1}^{T} L ( {\underline{x}}_{f t} ; {W}_{f} )$$

$$L ( {\underline{x}}_{f t} ; {W}_{f} ) = c o n s t + ( l n d e t {W}_{f} {W}_{f}^{H} - {\vert {{y}_{ft}}_{—} \vert}_{1} )$$

(This assumes that the demixed output y is drawn from a Laplace distribution; the subscript “1” indicates the L1 norm).

The objective is to find W_{f} that maximises the likelihood. As operations are in the complex domain the Wirtinger derivative ∇L is used. Defining sign( . . . ) as the element wise complex sign operator:

$$∇ L = {\sum }_{t = 1}^{T} ( 2 {W}_{f}^{- H} - sign ( {{y}_{ft}}_{—} ) {\underline{x}}_{f t}^{H} )$$

This can be computed by iteratively updating the estimate of W_{f} using the natural gradient. The natural gradient is the steepest ascent of L when projected onto an appropriate Riemannian manifold. In the present case the manifold of invertible matrices is used and the natural gradient δW_{f} is given by

δW_{f}∝∇LW_{f}^{H}W_{f}

With a step size of

$$\frac{{μ}_{k}}{2 T}$$

for each iteration there is obtained:

$${W}_{f} ← {W}_{f} + \frac{{μ}_{k}}{2 T} ∇ L {W}_{f}^{H} {W}_{f}$$

$${W}_{f} + {μ}_{k} ( {W}_{f}^{- H} - \frac{1}{2 T} {\sum }_{t = 1}^{T} sign ( {{y}_{ft}}_{—} ) {\underline{x}}_{ft}^{H} ) {W}_{f}^{H} {W}_{f}$$

$$( ( 1 + {μ}_{k} ) I - \frac{{μ}_{k}}{2 T} {\sum }_{t = 1}^{T} sign ( {{y}_{ft}}_{—} ) {{y}_{ft}^{H}}_{—} ) {W}_{f}$$

In implementations, for each frequency, ML-ICA performs the following algorithm:
1. Initialise W_{f}
2. For each iteration k∈1:K
   calculate

$${\underline{y}}_{ft} = {W}_{f} {\underline{x}}_{ft}$$

for each frame

$$b . G = \frac{1}{2 T} {\sum }_{t} sign ( {{y}_{ft}}_{—} ) {{y}_{ft}^{H}}_{—}$$

$$c . {W}_{f} ← ( ( 1 + {μ}_{k} ) I - {μ}_{k} G ) {W}_{f}$$

The algorithm has converged when G=I. Here and later G is a gradient value related to the gradient of the cost function, and closely related to the natural gradient. The number of iterations K can be either be fixed or we can use a convergence criterion such as ∥I−G∥_{F}²<ϵ (where F denotes the Frobenius norm).

Any rank S matrix can be used to initialise W_{f}. In the absence of any prior information, a good candidate is to use principal component analysis and initialise W_{f} to the S most significant components. It will be appreciated that the algorithm is used for each frequency f to determine the set of demixing matrices W.

The main computational burden is steps 2a and 2b which are each O(SMT).

The factor of ½ in calculating G only affects the scaling of the final result and may be ignored in implementations.

The expression of the step size of

$$\frac{{μ}_{k}}{2 T}$$

in terms of T is merely for mathematical convenience. The step size may be changed (reduced) from one iteration to the next, but this is not necessary; in practice a fixed value of μ=0.5 has been found to work well.

### Frame Selection/Weighting and Importance Metric

As mentioned above, a frame buffer store may use an importance metric to overwrite unimportant frames when updating the frame buffer with new frames.

This is a separate process to the BSS process and can be used to obtain metadata about the sources present, for example in captured frames stored in a frame buffer. Such metadata may include information such as the source activity envelopes and location information: it is generally an easier problem to obtain this data than to perform the BSS.

In preferred embodiments, the basic principle is to use this metadata to calculate an ‘importance’ value for each frame. We describe below some examples of heuristics which may employ frame metadata to determine an importance metric for a frame; one or more of these approaches may be used separately or in combination. Where a relative importance is defined (‘lower’ or ‘higher’), this may be relative to an average value of an importance metric for the frames.
a) Frames that contain audio considered to be an echo, background noise, or other miscellaneous loud or impulsive events like door slams may be assigned a relatively lower importance metric.
b) Frames that are very quiet may be assigned a relatively lower importance metric as they are unlikely to contain useful information for BSS.
c) Older frames may be assigned a relatively lower importance metric.
d) In a case where there are more sources present than the BSS procedure can separate (i.e. more sources than microphones), one or more of the following techniques may be used:

The sources may be classified into “required” and “extraneous” sources. Here “required” refers to a source being required for the purposes of separating a target source from other sources which may either be other potential target sources or one or more sources of interference. Thus a source of interference may be required in the blind source separation procedure so that it can be “tuned out”, that is separated from one or more other sources present. By contrast, an extraneous source is one which is not required either as a target source or as a source of interference to remove: It is often better to concentrate on separating the relevant sources and ignore the extraneous ones. Including the extraneous sources in the BSS problem can damage how well the relevant sources are separated, whereas excluding them simply means that a filtered version of the extraneous sources will be present on each output. Excluding the extraneous sources is generally the more palatable option, although clearly perfect exclusion is not always possible. A source may be classified into “required” and “extraneous” based on, for example, one or more of the following.
i. Prior information such as a predetermined or user selected/specific location
ii. Identification of a source as a commonly occurring loud source (e.g. a steady fan noise) may be used to define a source as “required”
iii. Identification of a source as a recently occurring source may be used to define a source as “required” (the most recently occurring sources are most likely to be active again in future)
iv. Acoustic activity related to the reference signal/echo return, i.e., sound that is identified as belonging to the output of a playback device, and/or the acoustic echo therefore, and/or the acoustic echo of a user's voice.

Once a classification has been made frames that contain one or more required sources may be given a higher important metric than frames that contain one or more extraneous sources.
c) The contribution of (required) sources may be equalised: without equalisation a commonly occurring source will have more influence in the BSS algorithm than an infrequent one.

Once importance metric values or weights have been allocated to the frames the procedure can then use the importance values in updating a frame buffer storing past frames (see below). In particular, rather than overwriting the oldest frames, the procedure can instead choose to overwrite the frames deemed unimportant (that is, a frame with less than a threshold value of importance metric and/or a stored frame with a lower importance metric than the new, incoming frame). This allows embodiments of the system to make maximum use of the frame buffer to record history relevant to the source separation problem. Preferably, once the frame buffer has been updated, the importance values are recalculated.

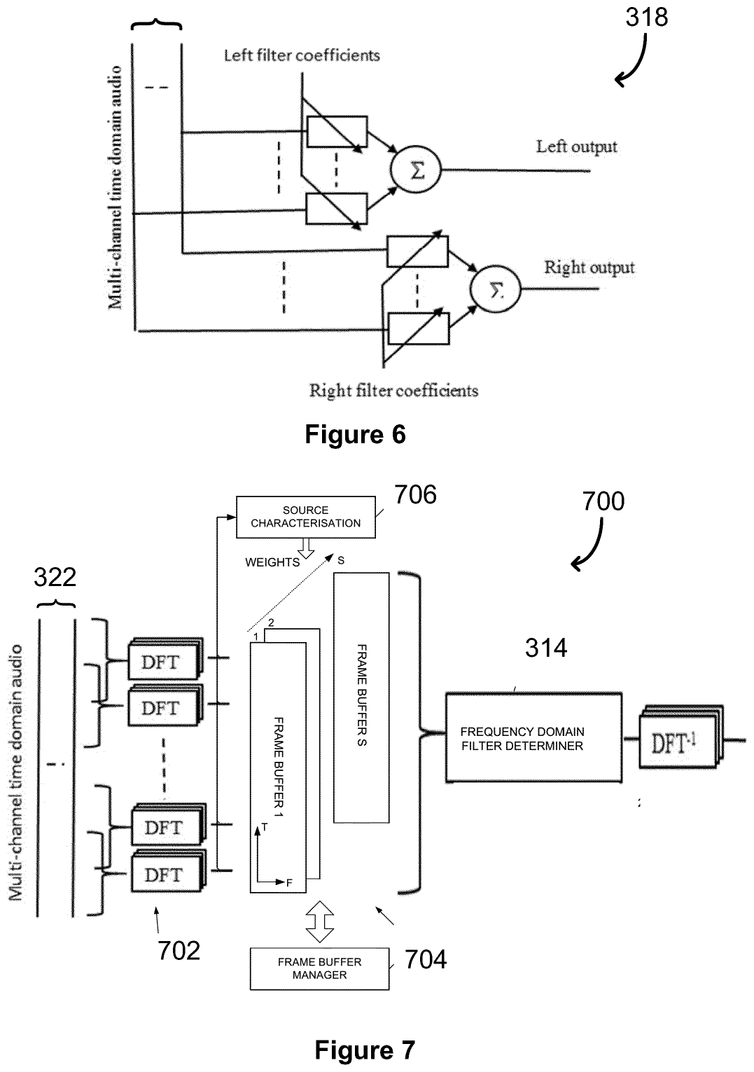

FIG. 6 shows an example spatial filter for the method and system disclosed, consistent with a possible embodiment of the spatial filter 318 shown in FIG. 3. The illustrated spatial filter 318 shows a multi-channel linear discrete convolution filter in which the output is the sum of the audio input channels convolved with their respective filter co-efficients. In this example, two microphones are present in the mic device 302, denoted ‘left’ and ‘right’ in FIG. 6. In embodiments, a multi-channel output such as a stereo output is provided. For a stereo output either the spatial filter output may be copied to all the output channels or more preferably, as shown in FIG. 6, a separate spatial filter is provided for each output channel. This latter approach is advantageous as it can approximate the source as heard by each microphone.

FIG. 7 shows an example implementation of frame buffer management for use in the system. FIG. 7 also illustrates time-frequency and frequency-time domain conversions for the frequency domain filter coefficient determiner 314 of FIG. 3. In embodiments each audio channel may be provided with an STFT (Short Time Fourier Transform) module 702 each configured to perform a succession of overlapping discrete Fourier transforms on an audio channel to generate a time sequence of spectra. Transformation of filter coefficients back into the time domain may be performed by a set of inverse discrete Fourier transforms.

The Discrete Fourier Transform (DFT) is a method of transforming a block of data between a time domain representation and a frequency domain representation. The STFT is an invertible method where overlapping time domain frames are transformed using the DFT to a time-frequency domain. The STFT is used to apply the filtering in the time-frequency domain; in embodiments when processing each audio channel, each channel in a frame is transformed independently using a DFT. Optionally the spatial filtering could also be applied in the time-frequency domain, but this incurs a processing latency and thus more preferably the filter coefficients are determined in the time-frequency domain and then inverse transformed back into the time domain. The time domain convolution maps to frequency domain multiplication. In addition, and with reference to FIG. 5, optionally the mic frame buffer 502 and reference frame buffer 504 may be included between the DFTs and the main frame buffer.

As shown in FIG. 7, a frame buffer system is provided comprising a T×F frame buffer X for each microphone 1 . . . M. These store time-frequency data frames in association with frame weight/probability data as previously described. In embodiments the microphone STFT data are interleaved so that there is one frame buffer containing M×F×T STFT points. A frame buffer manager 704 operates under control of the procedure to read the stored weights for frame selection/weighting.

In embodiments the frame buffer manager 704 also controls one or more pointers to identify one or more location(s) at which new (incoming) data is written into a buffer, in particular to overwrite relatively less important frames with relatively more important frames. Optionally frame buffer system 700 may comprise a plurality of sets of frame buffers (one frame buffer per microphone), e.g., where two microphones are present, having one buffer to accumulate new data whilst previously accumulated data from a second buffer is processed; then the second buffer can be updated. In embodiments a frame buffer may be relatively large—for example, single precision floating point STFT data at 16 kHz with 50% overlap between frames translates to ˜8 MB of data per microphone per minute of frame buffer. However, the system may accumulate new frames in a temporary buffer while calculating the filter coefficients and at the beginning of the next update cycle update the frame buffer from this temporary buffer (so that a complete duplicate frame buffer is not required).

The frame weights are determined by a source characterisation module 706. In embodiments this determines frame weights according to one or more of the previously described heuristics. This may operate in the time domain or (more preferably) in the time-frequency domain as illustrated. More particularly, in embodiments this may implement a multiple-source direction of arrival (DOA) estimation procedure. The skilled person will be aware of many suitable procedures including, for example, an MVDR (Minimum Variance Distortionless Response) beamformer, the MUSIC (Multiple Signal Classification) procedure, or a Fourier method (finding the peaks in the angular Fourier spectrum of the acoustic signals, obtained from a combination of the sensor array response and observations X).

The output data from such a procedure may comprise time series data indicating source activity (amplitude) and source direction. The time or time-frequency domain data or output of such a procedure may also be used to identify: a frame containing an impulsive event; and/or frames with less than a threshold sound level; and/or to classify a sound, for example as air conditioning or the like.

### Scaling Ambiguity

Embodiments of the above described procedure extract the source estimates up to an arbitrary diagonal scaling matrix B_{f}. This is an arbitrary filter, since there is a value of B_{f} at each frequency (this can be appreciated from the consideration that changing the bass or treble would not affect the independence of the sources). The arbitrary filter can be removed by considering what a source would have sounded like at a particular microphone.

In one approach, conceptually the scaling ambiguity can be resolved by taking one source, undoing the effect of the demixing to see what it would have sounded like at one or more of the microphones, and then using the result to adjust the scaling of the demixing matrix to match what was actually received (heard)—that is, applying a minimum distortion principle. However although this is what is taking place conceptually we only require knowledge of the demixing matrix and it is not necessary to actually undo the effect of the demixing.

The procedure can estimate the sources as received at the microphones using a minimum distortion principle as follows:
Let [symbol] be a combined demixing filter including any dimension reduction or other pre processing.
Let [symbol] be the pseudo inverse of [symbol] . This is a minimum distortion projection from the source estimates back to the microphones.
Let S(s) be a selector matrix which is zero everywhere except for one element on the diagonal S(s)ₛₛ=1.

To project source estimate s back to all the microphones we use

W′_{f}(s)= [symbol] S(s) [symbol] (25)

[symbol]

(s)=W′_{f}(s)X_{f} (26)

Matrix S(s) selects one source s, and equations (25) and (26) define an estimate for the selected source on all the microphones. In equation (26) [symbol] (s) is an estimate of how the selected source would have sounded at microphones, rather than an estimate of the source itself, because the (unknown) room transfer function is still present.

### Frequency Permutation

In embodiments of the techniques we describe, the input signals are split into frequency bands and each frequency band is treated independently, and the results at different frequencies are then aligned. Thus in a matrix W_{f} each row corresponds to a source, and the rows of the matrices W_{f} for the frequencies concerned are permuted with the aim that a particular row always corresponds to the same source (row 1=source 1 and so forth). The skilled person will be aware of many published techniques for resolving the permutation ambiguity. For example, in one approach this may be done by assuming that when a source is producing power at one frequency it is probably also active at other frequencies.

### Source Selection

Oftentimes it is only a subset of the sources that is desired; because there may be a global permutation, it can be useful to estimate which of the sources are the desired ones—that is, the sources have been separated into independent components but there is still ambiguity as to which source is which (e.g. in the case of a group of speakers around a microphone, which source s is which speaker). In addition embodiments of the procedure operate on time slices of the audio (successive groups of STFT frames) and it is not guaranteed that the “physical” source labelled as, say, s=1 in one group of frames will be the same “physical” source as the source labelled as s=1 in the next group of frames (this depends upon the initialisation of W, which may, for example, be random or based on a previous group of frames).

Source selection may be made in various ways, for example on the basis of voice (or other audio) identification, or matching a user selected direction. Other procedures for selecting a source include selecting the loudest source (which may comprise selecting a direction from which there is most power); and selecting based upon a fixed (predetermined) direction for the application. For example a wanted source may be a speaker with a known direction with respect to the microphones. A still further approach is to look for a filter selecting a particular acoustic source which is similar to a filter in an adjacent time-frequency block, assuming that similar filters correspond to the same source. Such approaches enable a consistent global permutation matrix (P) to be determined from one time-frequency block to another.

In embodiments, to match a user-selected direction knowledge of the expected microphone phase response θ_{jf} from the indicated direction may be employed. This can either be measured or derived from a simple anechoic model given the microphone geometry relative to an arbitrary origin. A simple model of the response of microphone j may be constructed as follows:

Given the known geometry for each microphone we can define
c is the speed of sound.
xⱼ is the position of microphone j relative to an arbitrary origin in real space
d is a unit vector corresponding to a chosen direction towards the desired source in the same coordinate system as xⱼ.
f_{Hz} is the frequency (in Hertz) associated with STFT bin f.

The far field microphone time delay, τⱼ, in seconds relative to the origin is then given by

$${τ}_{j} = \frac{- {\underline{x}}_{j}^{T} \underline{d}}{c}$$

This leads to a phase shift for microphone j of

θ_{jf}=e^{2πτ}^{ⱼ}^{f}^{_{Hz}}ⁱ

However the phase response θ_{jf} is determined, the chosen source s is the source whose corresponding row in [symbol] maximises the phase correlation:

$$s = {argmax}_{k} {\sum }_{f} {\vert {\sum }_{j} \frac{\vert \vert}{} {θ}_{j f}^{*} \vert}^{2}$$

where the sum j runs over the microphones and θ_{jf} is the (complex) frequency/phase response of microphone j in the selected direction. In principle this approach could be employed to select multiple source directions.

The skilled person will appreciate that a similar approach enables one or more source directions to be determined from [symbol] , for example for weighting a (required or extraneous) source based on source direction.

No doubt many other effective alternatives will occur to the skilled person. For example other systems comprising a microphone device and a playback device may be substituted for the television system. The invention is not limited to the described embodiments and encompasses modifications apparent to those skilled in the art lying within the scope of the claims appended hereto. It should further be noted that the invention also encompasses any combination of embodiments described herein, for example an embodiment may combine the features of any one or more of the independent and/or dependent claims.

1. A method of capturing speech using a television system, the television system comprising a microphone device and a playback device, the method comprising:
using a first, playback device of the television system to play a tv audio signal to generate acoustic tv audio representing the tv audio signal;
using a microphone in a second, microphone device of the television system to capture a speech audio signal comprising a mixture of a first acoustic audio source comprising speech from a user and a second acoustic audio source comprising the acoustic tv audio;
obtaining a representation of the tv audio signal, wherein the representation of the tv audio signal lacks a well-defined synchronization with the tv audio signal; and
processing the speech audio signal using a semi-blind source separation process to separate the speech from the user from the acoustic tv audio and determine at least one audio signal component comprising the speech from the user and in which the acoustic tv audio is suppressed,
wherein the semi-blind source separation process uses the representation of the tv audio signal to guide the separation of the speech from the user from the acoustic tv audio, and
wherein the at least one audio signal component comprises the captured speech.

2. The method of claim 1 wherein the semi-blind source separation process comprises a process that separates the speech from the user from the acoustic tv audio dependent upon an information content of the speech and the acoustic tv audio.

3. The method of claim 1 wherein processing the speech audio signal using the semi-blind source separation process determines a plurality of the audio signal components, further including an audio signal component comprising the acoustic tv audio and in which the speech from the user is suppressed; and wherein using the representation of the tv audio signal to guide the separation of the speech from the user from the acoustic tv audio comprises resolving a source ambiguity by identifying one or more of the audio signal components which are similar to the acoustic tv audio.

4. The method of claim 1 wherein the microphone comprises a microphone array, the method comprising using the microphone array to capture a multichannel speech audio signal, each channel of the multichannel speech audio signal comprising a mixture of speech from a user and the acoustic tv audio, and processing the channels of the speech audio signal using the semi-blind source separation process to separate the speech from the user from the acoustic tv audio.

5. The method of claim 1 wherein the semi-blind source separation process comprises:
converting the speech audio signal to time-frequency domain data comprising a succession of time-frequency data frames for a succession of time windows, each having a plurality of frequency bands; and
determining a set of de-mixing matrices, one for each of the frequency bands, to apply to each time-frequency data frame to separate the speech from the user and the acoustic tv audio, the set of de-mixing matrices defining a vector of separated outputs.

6. The method of claim 5 wherein each row of one of the de-mixing matrices corresponds to one of the sources; and permuting the rows of the de-mixing matrices using the representation of the tv audio signal such that for the succession of time windows each row corresponds to the same source.

7. The method of claim 5 comprising converting the set of de-mixing matrices from the time-frequency domain to the time domain to determine a time domain demixing filter; and applying the time domain demixing filter to the speech audio signal in the time-domain to determine the least one audio signal component comprising the speech from the user and in which the acoustic tv audio is suppressed.

8. The method of claim 5 comprising constructing, from the demixing matrices, a multichannel filter to operate on the time-frequency data frames; applying the multichannel filter to said time-frequency domain data to determine de-mixed time-frequency data; and converting the de-mixed time-frequency data to the time domain to recover de-mixed time domain data for the least one audio signal component comprising the speech from the user and in which the acoustic tv audio is suppressed.

9. The method of claim 1, wherein the processing the speech audio signal using semi-blind source separation further comprises:
reducing a time misalignment between the speech audio signal and the representation of the tv audio signal, prior to guiding the separation of the speech from the acoustic tv audio.

10. The method of claim 9, further comprising:
converting each of the speech audio signal and the representation of the tv audio signal into time-frequency domain data, each comprising a succession of time-frequency data frames;
determining a pair of frames that are a closest match, comprising determining that a data frame of the converted representation is a closest match to a component of a data frame of the converted speech audio signal, wherein the component corresponds to the second acoustic audio source comprising the acoustic tv audio; and
indicating that the pair of frames relate to the same or nearby point in time.

11. The method of claim 1 wherein obtaining a representation of the tv audio signal comprises obtaining a reduced bandwidth representation of the tv audio signal.

12. The method of claim 11 wherein processing the speech audio signal comprises processing a digitized sample of the speech audio signal, and wherein the reduced bandwidth representation comprises a representation of an energy in the tv audio signal in a set of different frequencies at time intervals longer than an interval between the digitized samples of the speech audio signal.

13. The method of claim 1 wherein obtaining the representation of the tv audio signal comprises sending representation of the tv audio signal from the first, playback device to the second, microphone device.

14. The method of claim 13 wherein the second, microphone device comprises a set top box.

15. The method of claim 13 wherein the sending comprises sending over an HDMI audio return channel.

16. The method of claim 1 comprising obtaining the representation of the tv audio signal at the second, microphone device, and sending the tv audio signal from the second, microphone device to the first, playback device.

17. The method of claim 1 comprising using the television system as a video phone or video conferencing system, wherein the first, playback device provides an audio and video output for the video phone or video conferencing system, wherein the second, microphone device captures speech of a user of the video phone or video conferencing system, wherein the at least one audio signal component comprising the captured speech is provided for onward transmission to a remote video phone or video conferencing system station.

18. A method of processing an audio signal, the method comprising:
playing a first audio signal to generate first acoustic audio representing the first audio signal;
capturing a second audio signal using a microphone, the second audio signal comprising a mixture of a first acoustic audio source comprising the first acoustic audio and a second acoustic audio source comprising a target audio;
obtaining a representation of the first audio signal, wherein the representation of the first audio signal lacks a well-defined synchronization with the first audio signal; and
processing the second audio signal to provide a processed audio signal, by using a semi-blind source separation process to separate the target audio from the first acoustic audio and determine at least one audio signal component comprising the target audio and in which the first acoustic audio is suppressed,
wherein the semi-blind source separation process uses the representation of the first audio signal to guide the separation of the target audio from the first acoustic audio.

19. The method of claim 18 wherein the semi-blind source separation process comprises:
converting the second audio signal to time-frequency domain data comprising a succession of time-frequency data frames for a succession of time windows, each having a plurality of frequency bands;
determining a set of de-mixing matrices, one for each of the frequency bands, to apply to each time-frequency data frame to separate the target audio from the first acoustic audio; and
using the representation of the first audio signal to resolve an ambiguity between one or both of i) an allocation de-mixed sources to first acoustic audio, and ii) an allocation of de-mixed frequency bands to the sources.

20. A non-transitory storage medium storing processor control code to implement the method of claim 1.

21. (canceled)
